(19) United States
(12) Patent Application Publication
(10) Pub. No.: US 2006/0177191 A1
(43) Pub. Date: Aug. 10, 2006

(54) TERMINATOR BY TAPERING FIBER OPTIC

(75) Inventor: ROLAND COTE, VERDUN (CA)

Correspondence Address: ROLAND COTE, 4 RUE COTE, PETITE-VALLEE, QC, G0E 1Y0, CA

(73) Assignee: ROLAND COTE, VERDUN (CA)

(21) Appl. No.: 11/307,935

(22) Filed: Feb. 28, 2006

(30) Foreign Application Priority Data
Dec. 23, 2004 (CA) 2,488,005

(51) Int. Cl. G02B 6/36; G02B 6/00

(52) U.S. Cl. 385/139; 385/76

(57) ABSTRACT

A Terminator by Tapering Fiber Optic (herein after named TermTaper) made directly using a single mode optical fiber to reduce the back reflection in an installed optical fiber link, which occurs when a guided incident optical signal encounters an index of refraction change at a glass-air transition. The single mode fiber has at one end, a first length of exposed fiber which is obtained by way of stripping the jacket from that portion of fiber. The bare fiber is positioned in a suitable heating set in order to enable a biconical taper to be formed on that portion of bare fiber. The biconical taper contributes to obtain a return loss of better than 55 dB for any guided optical signal that propagates through the TermTaper. The TermTaper is assembled in any type of suitable mounting device.

### BACKGROUND OF THE INVENTION

1. Field of the Invention

This invention relates to the field of optical fiber and in particular to terminators that use the application of a biconical taper for operation with an installed fiber link in an optical fiber network.

2. Related Art

Previous inventors while investigating optical attenuation material applications, i.e., DiGiovanni et al, in U.S. Pat. No. 5,572,618 issued in 1996, provided a discussion of an “Optical attenuator”. King et al, in U.S. Pat. No. 5,619,610 (1997), proposed an “Optical terminator” while Dumais et al, in U.S. Pat. No. 5,710,848 (1998) presented an “Optimized non-linear effect tapered optical fiber and method of making same”. Finally, Pavlath, in U.S. Pat. No. 6,31 7,547 (2001) presented work on optical fiber taper applications in “Optical fiber for reducing optical signal reflections”. None of these references presents an optical terminator by tapering a fiber optic.

3. Historical

A few years ago, it was suggested that the graphic result of an optical time domain reflectometer (OTDR) fiber optic measurement (e.g. loss and integrity of fiber light path) could be stored in a database as a fixed digital image or “signature” right at the time of the project acceptance date. The objective was to monitor change, over time, for fiber and connections, and facilitate the identification of break locations when accidental damage occurs by comparing the latest trace with previously stored records. The “signature” trace that represents the characteristics of the fiber light path under test is unique for each case. However, the missing information about the status of the last connector on which any “ready for service” fiber light paths terminate, jeopardized the deployment of that project as planned. The use of OTDR for unidirectional fiber light path testing presents some drawbacks. Particularly, the lack of showing the status of the last connector in which the end face acts as a mirror when slightly guided light crosses the glass-air boundary. In fact, the unmatched refractive index of both glass (˜1.5) and air (˜1.0) media causes a reflection of around 4% of the incident signal power. This percentage depends on the value of the refractive index of the doped fiber region, i.e. core, which is slightly lower than of this one for pure glass. Then, the fiber core guides the reflected power (back reflection) directly to the source. This back reflection acts as a source of noise for optical systems working on fiber links. In order to characterize the last connection for data validation of the “signature” trace for a fiber light path, the termination shall provide an event “return loss” (“event” describing the result of an OTDR measurement of the reflected optical incident power, far from dead zone, at one or more connections on a fiber link) of at least 30 dB. This is a rule-of-thumb value that a fiber optic monitoring system using OTDR can detect an open condition (e.g. in surveillance mode) at the far end of the light path. The open condition hereafter refers to the reading of the event “return loss” for the incoming signal when it reflects at the boundary of the formed glass-air medium at a connector end face. OTDRs on the market provide a reading of 1 4-1 5 dB for this condition. For monitoring degradation at the far end connection of a properly functioning optical link, the event “return loss” has to be in the 40 dB figure or higher range. In order to achieve accurate event “return loss” readings, the OTDR shall launch a LASER pulse 1 00 nanosecond width, at both wavelengths 1310 and 1 550 nanometer as a minimum requirement.

### SUMMARY OF THE INVENTION

This invention provides a Terminator by Tapering Fiber Optic fabricated with commercially available components and tools and without any matching gel or polymer material (King et al) to attenuate an optical signal.

This invention provides also a device suited for the wavelength range 1260-1650 (this range depends on the type of single-mode fiber on the market) nanometers while the optimized refractive index matching is as accurate as SMF can provide so in the range of one part in ten thousands (0.0001). A termination quality of 40 dB for event “return loss” is reachable when using bare fiber adapter connector as holder, for ST, SC, FC and other type of connectors.

The above description shows that the invention relates only to a well-known means of modifying the shape of a glass element by way of a heat source. However, this has a tremendous impact when glass is an optical fiber. The light-guiding properties change and present new applications which then results in an optical termination. A comparison with other similar products shows that the difficulty to match fiber refractive index disappear because the terminator is an optical fiber piece itself. Thus, the matching accuracy rises to one part in ten thousand instead in one part in hundred for existing termination devices. In addition, the “return loss” (e.g. RL) calculated is not a concern either because the taper “traps” most of the incoming optical power (e.g. from an optical source) so the RL depends more on the quality of the connector end face (e.g. ferrule) polishing in which the terminator is inserted. Then, the matter of the terminator influencing the RL rating depends on the existing manner by which the terminator itself terminates: i.e. interfaces with the optical fiber. One could even request a super polished connector (SPC) end face, an ultra polished connector (UPC) end face or an angle polished connector (APC) end face depending on the requirement of RL criteria for the application. There is no limitation for the invention to fit within the existing terminating components market for optical fiber.

In addition, this invention can be useful to a fiber-optic supplier since it is:

(1)Well suited for use in any kind of fiber patch panel and distribution frame on the market

(2) Designed to reduce manufacturing cost: Benefit economy of volume for commercial components

(3) Designed to cut down production cost: Working people with hands on skills or custom-made setup with automation

(4) Designed to have short time to market: Use of already tested components will speed up the tests to meet technical requirements for Telecom Outside Plant Engineering or those by Telcordia

### BRIEF DESCRIPTION OF THE DRAWINGS

The preferred embodiment and its mode of operation will be more clearly understood from the following detailed description when read with the appended drawing in which:

FIG. 1 is a perspective view of a piece of a rolled SMF optical fiber used to make the optical terminator;

FIG. 2 is a perspective view of the optical fiber of FIG. 1 with a part of its jacket stripped of;

FIG. 3 is a perspective view of the optical fiber of FIGS. 1 and 2 once the biconical taper formed; streaked lines show the taper zone;

FIG. 4 is a perspective view of the optical fiber of FIGS. 1, 2 and 3 with extra fiber beyond the taper cut, stripped of its jacket at the opposite end and perpendicularly cleaved, then forming the device “Terminator by Tapering Fiber Optic”;

FIG. 5 is a perspective view of the optical fiber of FIG. 4 with indications of longitudinal and cross views;

FIG. 6 is the longitudinal view A-A as per FIG. 4; the drawing is not to scale;

FIG. 7 is the cross-section view B-B as per FIG. 4; the drawing is not to scale;

FIG. 8 is a longitudinal axial section of a SC type connector with the TermTaper in place; the drawing is not to scale;

FIG. 9 is a perspective view of the connector device as per FIG. 8 mated, via a mating sleeve to a terminated fiber cable; the drawing is not to scale.

### DESCRIPTION OF THE PREFERRED EMBODIMENT

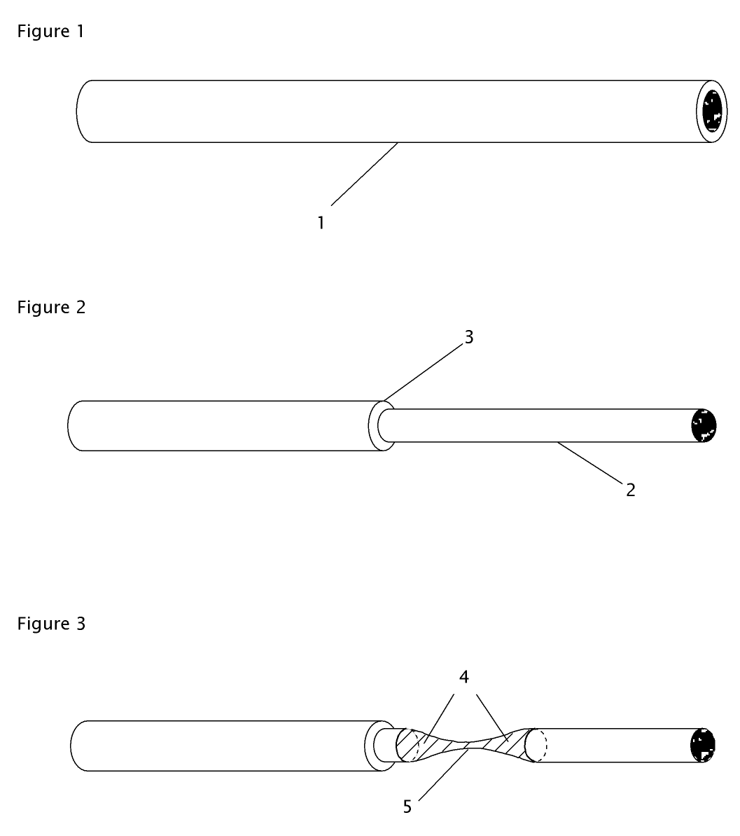

FIGS. 1-4 show the steps in forming a terminator by tapering fiber optic.

FIG. 1 shows the embodiment 1 as a 15 cm (e.g. to facilitate handling) piece cut from a rolled single mode fiber (SMF), such as CORNING SMF-28e.

FIG. 2 shows the piece of fiber 1 partially stripped of its jacket 3, 1 2, 1 5; this work exposes 7-8 cm of bare fiber 2 clean with appropriate wipes and alcohol.

A deformation by tapering an area of the optical waveguide (e.g. optical fiber) influences its guiding properties. A fusion set is suitable for this action. On the other hand, there are other ways (e.g. micro burner) to do it without affecting the functionality of the embodiment.

Here is some background regarding how the taper modifies the optical guiding property of fiber. The guiding property of fiber demonstrates by mathematics formulae involve mainly, Maxwell's equations, “Poynting vector” equation for intensity of propagating signal, vector, and scalar wave equation. Then, if one consider the fiber as a weakly guiding waveguide, the resulting equations resolve in circular coordinates, have as solutions, Bessel functions J and K. These provide a representation for the optical power distribution (e.g. fundamental mode (HE₁₁)) in the waveguide. TheJ function applies for the core when K is for the cladding. The conditions at the refractive index boundary core/cladding are demonstrated using proper limit values for integration. If one changes the physical shape (e.g. straight cylinder) of optical fiber, this makes a change in its guiding property. For example, bending the fiber and performing an end-to-end loss test at the 1 550 nm wavelength results in a noticeable loss in the power of the launched optical signal. Then, repeating the bending action around a 1-cm diameter mandrel and wound three times and held, performing the same test results in a complete attenuation of the launched optical signal.

In the case of tapering the cylindrical shape, the fiber offers various guided signal behaviors that could be used for many applications; for example, Dumais eta/in the U.S. Pat. No. 5,71 0,848. In the present invention, the taper allows optical power to vanish from the core to a “sacrifice” core/cladding and acts as an interferometer for the guided wavelengths. Then, there is a zone of constructive light pattern or destructive pattern in the taper area depending of the taper shape. All of the above results in a very weak portion of the light coming back to the source once it has gone through the biconical taper and reflected back from the end of the light path, having passed through the taper twice. This is the main requirement for a terminator. The following paragraphs detail the tapering process.

Using a fusion set, such as COMPACT FUSION SET™ (CFS) (herein after named set), the still jacketed device end is put in place between the opened left latches, aligned such that a bare fiber section is exposed in the fusion spot area and then, the latches are closed. The manual operation leaves the bare fiber half-free, putting down on the right-opened latches arm. Then, the following steps consist in pushing the camera mobile arm holder in a lock position and turning on the set. The bare fiber that lay down in fusion spot area appears on the LCD monitor screen.

At this time, the fusion set is ready for operation, in this case simultaneously pressing the “pre-fuse” button while manually holding the bare fiber end; i.e. with fingers: in order to apply traction on the device. These two actions are coordinated in observing the image of the fiber. As the deformation occurs upon the electric arc (e.g. bright flash at the screen), the traction has to vanish.

FIG. 3 shows the embodiment with the biconical taper 4 for which the length is in the range of 100-125 microns. The enlargement/reduction taper ratio of a sample is typically 1:5. This means that the diameter at the “waist” 5, 10 and 1 3 is approximately ⅕ of the optical fiber diameter 1 4.

It was experimented a taper 4 ratio up to 1:7 which revealed as to be properly terminating a fiber light path. This way of making the biconical taper necessitates a tuning accordingly the require loss of optical power in the taper zone. A figure of 99% (or 20 dB) of loss optical power is expected.

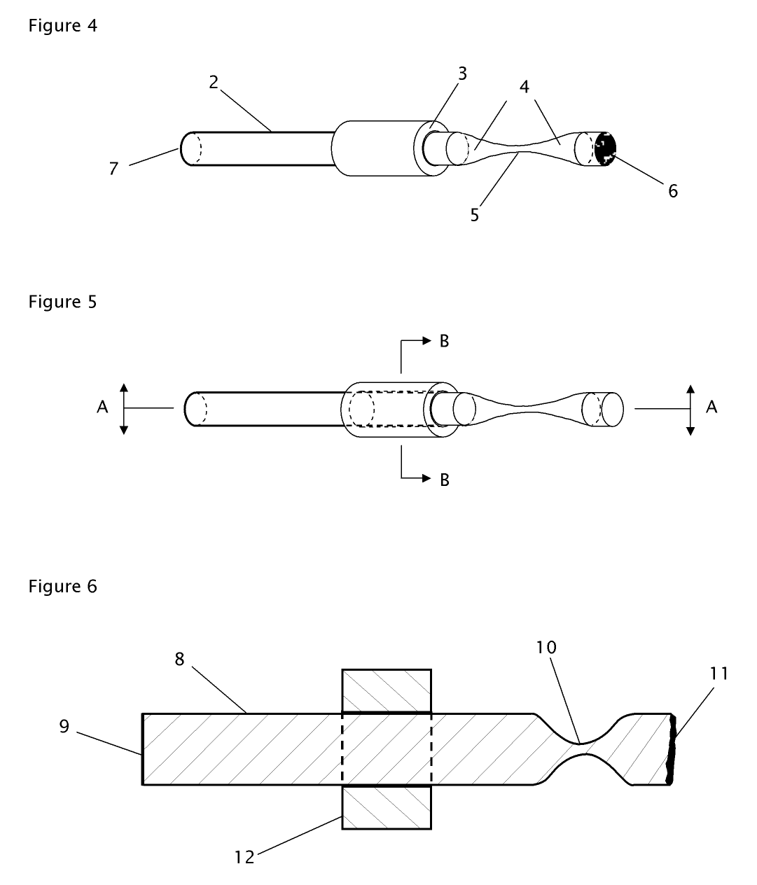

FIG. 4 shows the other operations on the optical fiber. The extra bare fiber exceeding the biconical taper is cut 6, 11 at around a half centimeter beyond the taper zone 4; this is not critical. As a handy mean to work with the embodiment (and to avoid breaking the taper 5, 1 0), an appropriate thermal shrink sleeve (˜1 cm long) is slid over the fiber, centered on the taper and heated (flame of a candle) until secured in place (e.g. tight enough so one can hold safely the device). During the work, the bare fiber 2 in contact with fingers has an appropriate cleaning up as many times as required.

Referring again to FIG. 4, and FIG. 6, the embodiment has the opposite side of the biconical taper partially stripped of its jacket to expose bare fiber 2, 8. Then, the tip end 7, 9 has a perpendicular cleave made by the use of a fiber cleaver or a scribe tool. Once finished, the sample has an overall length of ˜4.5 cm or less compared to 5.5 cm for the assembled connector. This demonstrates that the TermTaper fits well within the dimensions of common, commercially available assembled connectors.

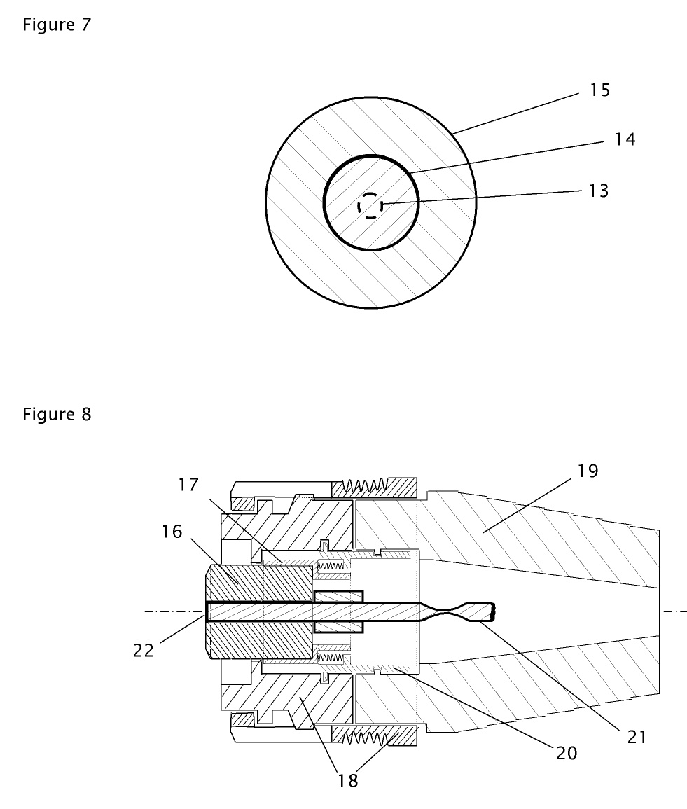

FIGS. 5, 6, and 7 show respectively a representation of the embodiment, its longitudinal and cross-section views.

Then, the embodiment has a verification of its functionality and performance by placing it in a bare fiber adapter or a pre-assembled connector. As a measurement result with an optical time domain reflectometer set for 1 550 nanometer wavelength and pulse width at 1 00 nanosecond, a sample typically allows a 40 dB event “return loss” when mated to the last connector of a fiber link carrying the optical signal. “Terminator by Tapering Fiber Optic” on the market, for example, a type SC, has to have an assembly according to common factory SC connector termination procedures for a cable. FIG. 8 represents a longitudinal axial section of a SC type connector assembly. This figure shows the following components as, ferrule mount 1 6, 1 7, connector body 1 8, boot 1 9 and coupling 20. Some of these may vary in shape according to the required field connector type used, such as FC, ST, or any other type that can hold a single mode optical fiber.

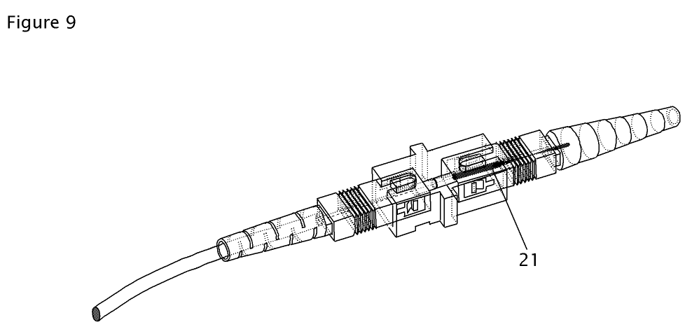

FIG. 8 shows also a longitudinal axial view of the embodiment 21 in its final position, glued inside the ferrule 16, and then, all of the assemblies 16 to 21 having the end face 22 polished according to the field requirement. FIG. 9 shows a perspective view of a typical field situation, where the embodiment 21 performs as a terminator.

What is claimed is:

1. A Terminator by Tapering Fiber Optic (herein after named TermTaper) made directly using a single mode optical fiber to reduce the back reflection in an installed single mode optical fiber link, which occurs when a guided incident optical signal encounters an index of refraction change at a glass-air transition created when the installed single mode fiber is connectorized and provided with a predetermined connector end face, the TermTaper comprising:
a piece of single mode fiber having at one end, a first length of exposed fiber which is obtained by way of stripping the jacket from that portion of the fiber; said bare fiber portion being positioned in a suitable heating apparatus in order to form a biconical taper on the bare fiber portion, the biconical taper contributing to provide an event return loss of better than 55 dB for any guided optical signal that propagates through both said installed optical fiber link and said TermTaper when said TermTaper is assembled in any type of suitable mounting device and optically connected to the installed optical fiber link, wherein the biconical taper is formed within a predetermined optimum or minimum enlargement/reduction ratio and length.

2. The TermTaper as defined in claim 1 wherein the piece of single mode fiber has a refractive index accurately matched to that of the optical fiber link to which said TermTaper is connected.

3. The TermTaper as defined in any one of claims 1 to 2 wherein the TermTaper is provided with a connector end face, via a bare fiber adapter connector, and wherein the adapter mounted TermTaper is connected, via its connector end face, to the optical fiber link at the connectorized end face thereof.

4. The TermTaper as defined in any one of claims 1 to 3 wherein the TermTaper, having been permanently assembled into a factory assembled mounting connector assembly and provided with a predetermined connector end face, is connected, via said connector end face, to the optical fiber link at the connectorized end face thereof.

5. The TermTaper as defined in claim 4 wherein the connector assembly into which the TermTaper is mounted, when connected to the optical fiber link connector, produces a typical connection interface between the two connector end faces, such as SPC, UPC or APC, such that the TermTaper is fully compatible with techniques for reducing guided optical signal return loss resulting from the back reflection created by the connection interface.

6. The TermTaper as defined in any one of claims 1 to 5 wherein the TermTaper is fabricated with commercially available components and tools.

7. The TermTaper as defined in any one of claims 1 to 6 wherein at least the biconical taper portion of the TermTaper is protected by a suitable thermal shrink sleeve.

8. A Terminator by Tapering Fiber Optic (herein after named TermTaper) made directly using a single mode optical fiber to reduce the back reflection in an installed single mode optical fiber link, which occurs when a guided incident optical signal encounters an index of refraction change at a glass-air transition created when the installed single mode fiber has the far end nonterminated, the TermTaper comprising: the single mode fiber of the installed single mode optical fiber link having a length of exposed fiber at its far end, which is obtained by way of stripping the jacket from that portion of the fiber; said bare fiber portion being positioned in a suitable heating apparatus in order to form a biconical taper on the bare fiber portion; and the biconical taper contributing to provide an event return loss of better than 55 dB for any guided optical signal that propagates through both said installed optical fiber link and said TermTaper, wherein the biconical taper is formed within a predetermined optimum or minimum enlargement/reduction ratio and length.

9. The TermTaper as defined in claim 8, wherein at least the biconical taper portion of the TermTaper is protected by a suitable thermal shrink sleeve.
